(19) United States
(12) Patent Application Publication
(10) Pub. No.: US 2011/0036290 A1
(43) Pub. Date: Feb. 17, 2011

(54) System For Manufacturing A Granule Covered Roofing Shingle Having A National Shingle Color

(76) Inventor: Edward R. Harrington, JR., Toledo, OH (US)

Correspondence Address: MacMillan, Sobanski & Todd, LLC, One Maritime Plaza, Fifth Floor, 720 Water Street, Toledo, OH, 43604, US

(21) Appl. No.: 12/911,326

(22) Filed: Oct. 25, 2010

Related U.S. Application Data
(63) Continuation-in-part of application No. 11/245,548, filed on Oct. 6, 2005, now Pat. No. 7,820,237.

(51) Int. Cl. B05C 9/12; B05C 1/08; B05C 19/04

(52) U.S. Cl. 118/37

(57) ABSTRACT

Systems for manufacturing national shingles are provided. The systems include the steps of establishing a standardized process for manufacturing shingles having standardized performance characteristics. The national shingles can be manufactured in more than one manufacturing facility, and further wherein the national shingles can be mixed on a common roof and provide a standardized performance.

### CROSS-REFERENCE TO RELATED APPLICATIONS

The present application is a continuation-in-part of co-pending U.S. patent application Ser. No. 11/245,548, entitled SYSTEM FOR MANUFACTURING A GRANULE COVERED ROOFING SHINGLE HAVING A NATIONAL SHINGLE COLOR, filed Oct. 6, 2005, the disclosure of which is incorporated herein by reference in its entirety.

### TECHNICAL FIELD

This invention relates to the manufacture of shingles, such as roofing shingles, and in particular, to shingles having blend drops of granules of various shades of color. More particularly, this invention pertains to an improved system for manufacturing such a shingle.

### BACKGROUND OF THE INVENTION

Asphalt-based roofing materials, such as roofing shingles, roll roofing and commercial roofing, are installed on the roofs of buildings to provide protection from the elements, and to give the roof an aesthetically pleasing look. Typically, the roofing material is constructed of a substrate such as a glass fiber mat or an organic felt, an asphalt coating on the substrate, and a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt coated sheet. Subsequently, the hot asphalt coated sheet is passed beneath one or more granule applicators which discharge protective and decorative surface granules onto portions of the asphalt sheet material.

In the manufacture of colored shingles, two types of granules are typically employed. Headlap granules are granules of relatively low cost used for the portion of the shingle that will be covered up on the roof. Colored granules or prime granules are of relatively higher cost and are applied to the portion of the shingle that will be exposed on the roof.

Colored granules are typically colored with a ceramic coating at a granule quarry and transported to a shingle manufacturing facility. Colored granules from different granule quarries are not used interchangeably at shingle manufacturing facilities. The colored granules from different granule quarries are not interchangeable because shingles made therefrom do not appear identical to the customer when used side-by-side on a roof.

To provide a color pattern of pleasing appearance, the colored portion of the shingles may be provided with areas of different colors. Usually the shingles have a background color and a series of granule deposits of different colors or different shades of the background color. A common method for manufacturing the shingles is to discharge blend drops onto spaced areas of the tacky, asphalt coated sheet. Background granules are then discharged onto the sheet and they adhere to the tacky, asphalt coated areas of the sheet between the granule deposits formed by the blend drops. The term “blend drop,” as used herein, refers to the flow of granules of different colors or different shades of color (with respect to the background color) that is discharged from a granule blend drop applicator onto the asphalt coated sheet. The patch or assemblage of the blend drop granules on the asphalt coated sheet is also referred to as the “blend drop.”

The apparatus for depositing granules onto the asphalt coated sheet is referred to as a blender, which can be comprised of a series of hoppers positioned to drop granules onto the sheet. In a typical blend drop shingle operation, the blender includes four hoppers that periodically deposit blend drops of granules of four different shades. The blender also includes a fifth hopper that drops background granules on the areas of the asphalt coated sheet that have not been covered by granules from the first four hoppers.

Various types of granule dispensing hoppers are known for use in granule blenders. One type of dispensing hopper is a fluted roll. Another type is a pneumatically assisted and controlled hopper as disclosed in U.S. Pat. No. 5,520,889 to Burton et al. Since the manufacture of shingles is carried out at high, continuous line speeds of hundreds of feet per minute, coordination and timing for the granule deposits from the various hoppers is imperative. The blender is usually operated by an electronic blender controller that provides signals to the various granule hoppers to impart the proper sequencing and duration of the blend drops of each blend drop color, and of the background color.

The various shades or colors of granules in each of the hoppers are typically created by mixing colored granules of different colors from several different supplies of granules, each of which is a pure or single color. For example, the first blend drop may be made by mixing three parts pure brown granules and one part pure black granules. The second blend drop may be made by mixing four parts pure brown granules and two parts pure white granules. Other combinations may be used for the third and fourth blend colors. The fifth hopper may contain background granules that are a color reflecting a combination of the granules from the first four hoppers.

One of the problems associated with the manufacture of shingles with blend drops is that the shade or color can deviate from the designed shade or color, and therefore be out of specification. This can occur because of mixing of colored granules from different granule quarries. Sometimes defects or variations in shades or colors cannot be detected during the manufacturing of the shingles. In such cases, the defect may not be discovered until the shingles are actually installed on a roof. As a result, shingle manufacturers often implement do not mix programs, wherein shingle manufacturing facilities are instructed not to mix like-colored granules from different quarries, and shingle customers are instructed not to mix shingles produced at different manufacturing facilities and/or on different production lines. It would be advantageous if there could be developed an improved system for manufacturing colored shingles.

### SUMMARY OF THE INVENTION

In accordance with embodiments of this invention there are provided systems for manufacturing national shingles. The systems include the steps of establishing a standardized process for manufacturing shingles having standardized performance characteristics. The national shingles can be manufactured in more than one manufacturing facility, and further wherein the national shingles can be mixed on a common roof and provide a standardized performance.

Various objects and advantages of this invention will become apparent to those skilled in the art from the following detailed description of the various embodiments, when read in light of the accompanying drawings.

### BRIEF DESCRIPTION OF THE DRAWINGS

FIG. 1 is a schematic elevational view of an apparatus for making shingles according to the invention.

FIG. 2 is a flow chart of a first embodiment of a system for manufacturing a granule covered roofing shingle in accordance with the system of this invention.

FIG. 3 is a flow chart of a second embodiment of a system for manufacturing a granule covered roofing shingle in accordance with the system of this invention.

FIG. 4 is a perspective view of a three-tab shingle illustrating a blend drop.

FIG. 5a is a first embodiment of a blend drop having an ovular shape.

FIG. 5b is a second embodiment of a blend drop having an ovular shape.

FIG. 5c is a third embodiment of a blend drop having an ovular shape.

FIG. 6a is a first embodiment of a blend drop having a rectangular shape.

FIG. 6b is a second embodiment of a blend drop having a rectangular shape.

FIG. 6c is a third embodiment of a blend drop having a rectangular shape.

FIG. 7a is a first embodiment of a blend drop having a parallelogrammatic shape.

FIG. 7b is a second embodiment of a blend drop having a parallelogrammatic shape.

FIG. 7c is a third embodiment of a blend drop having a parallelogrammatic shape.

FIG. 8a is a first embodiment of a blend drop having a parabolic shape.

FIG. 8b is a second embodiment of a blend drop having a parabolic shape.

FIG. 8c is a third embodiment of a blend drop having a parabolic shape.

FIG. 9 is a graph illustrating the relationship between blend drop intensity and distance of sheet travel.

FIG. 10 is a schematic representation of a blend drop pattern.

### DETAILED DESCRIPTION OF THE INVENTION

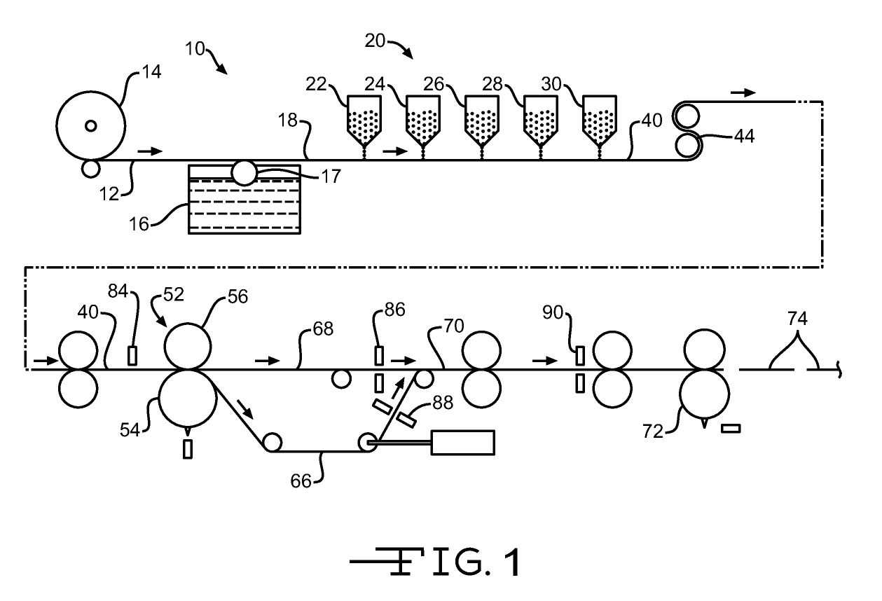

Referring now to the drawings, there is shown in FIG. 1 an apparatus 10 for manufacturing an asphalt-based roofing material according to the invention. The illustrated manufacturing process involves passing a continuous sheet 12 in a machine direction (indicated by the arrows) through a series of manufacturing operations. The sheet usually moves at a speed of at least about 200 feet/minute (61 meters/minute), and typically at a speed within the range of between about 450 feet/minute (137 meters/minute) and about 800 feet/minute (244 meters/minute).

In a first step of the manufacturing process, a continuous sheet of substrate or shingle mat 12 is payed out from a roll 14. The substrate can be any type known for use in reinforcing asphalt-based roofing materials, such as a non-woven web of glass fibers. The shingle mat 12 is fed through a coater 16 where an asphalt coating is applied to the mat 12. The asphalt coating can be applied in any suitable manner. In the illustrated embodiment, the mat 12 contacts a roller 17, which is in contact with a supply of hot, melted asphalt. The roller 17 completely covers the mat 12 with a tacky coating of hot, melted asphalt. However, in other embodiments, the asphalt coating could be sprayed on, rolled on, or applied to the sheet by other means. Typically, the asphalt material is highly filled with a ground stone filler material, amounting to at least about 60 percent by weight of the asphalt/filler combination.

The resulting asphalt coated sheet 18 is then passed beneath a series of granule dispensers 20 for the application of granules to the upper surface of the asphalt coated sheet. The granule dispensers can be of any type suitable for depositing granules onto the asphalt coated sheet. A granule dispenser that can be used is a granule blender of the type disclosed in U.S. Pat. No. 5,599,581 to Burton et al., or U.S. Pat. No. 6,610,147 to Aschenbeck, which are hereby incorporated by reference, in their entirety. The initial granule blender 22 deposits partial blend drops of background granules of a first color blend on the tab portion of the asphalt coated sheet 18 in a pattern that sets or establishes the trailing edge of subsequent blend drops of a second color blend (of an accent color) and a third color blend (of a different accent color). For purposes of this patent application, the first color blend and the background granules are synonymous. The use of initially applied partial blend drops to define the trailing edge of subsequent blend drops is useful where accurate or sharp leading edges are possible, but accurate trailing edges at high shingle manufacturing speeds are difficult. This technique of using initially applied partial blend drops is disclosed in U.S. Pat. No. 5,405,647 to Grubka et al., which is hereby incorporated by reference, in its entirety.

As is well known in the art, blend drops applied to the asphalt coated sheet are often made up of granules of several different colors. For example, one particular blend drop that is supposed to simulate a weathered wood appearance might actually consist of some brown granules, some dark gray granules, and some light gray granules. When these granules are mixed together and applied to the sheet in a generally uniformly mixed manner, the overall appearance of weathered wood is achieved. For this reason, the blend drops are referred to as having a color blend, which gives an overall color appearance. This overall appearance may be different from any of the actual colors of the granules in the color blend. Also, blend drops of darker and lighter shades of the same color, such as, for example, dark gray and light gray, are referred to as different color blends rather than merely different shades of one color.

As shown in FIG. 1, the series of dispensers 20 includes four color blend blenders 22, 24, 26, and 28. However, any desired number of blenders can be used. The final blender may be the background blender 30. Each of the blenders may be supplied with granules from sources of granules, not shown. After the blend drops are deposited on the asphalt coated sheet 18, the remaining, uncovered areas are still tacky with warm, uncovered asphalt, and the background granules from background blender 30 will adhere to the areas that are not already covered with blend drop granules. After all the granules are deposited on the asphalt coated sheet 18 by the series of dispensers 20, the sheet 18 becomes a granule covered sheet 40.

The granule covered sheet 40 is then turned around a slate drum 44 to press the granules into the asphalt coating and to temporarily invert the sheet so that the excess granules will fall off and will be recovered and reused. Typically, the granules applied by the background blender 30 are made up by collecting the backfall granules falling from the slate drum 44.

The granule covered sheet 40 is subsequently fed through a rotary pattern cutter 52 which includes a bladed cutting cylinder 54, backup roll 56, and a motor 58, as shown in FIG. 1. If desired, the pattern cutter 52 can cut a series of cutouts in the tab portion of the granule covered sheet 40, and also cut a series of notches in the underlay portion of the granule covered sheet 40.

The pattern cutter 52 also cuts the granule covered sheet 40 into a continuous underlay sheet 66 and a continuous overlay sheet 68. The underlay sheet 66 is directed to be aligned beneath the overlay sheet 68, and the two sheets are laminated together to form a continuous laminated sheet 70. As shown in FIG. 1, the continuous underlay sheet 66 is routed on a longer path than the path of the continuous overlay sheet 68. Further downstream, the continuous laminated sheet 70 is passed into contact with a rotary length cutter 72 that cuts the laminated sheet into individual laminated shingles 74.

In order to facilitate synchronization of the cutting and laminating steps, various sensors and controls can be employed. For example, sensors, such as photo eyes 86 and 88 can be used to synchronize the continuous underlay sheet 66 with the continuous overlay sheet 68. Sensors 90 can also be used to synchronize the notches and cutouts of the continuous laminated sheet with the end cutter or length cutter 72. Synchronization techniques for blend drops and cutting, such as those taught in commonly assigned U.S. Pat. No. 6,635,140 to Phillips et al. and U.S. application Ser. No. 09/515,928 to Elliott are hereby incorporated by reference in their entirety.

Referring now to FIG. 2, there is illustrated a flow chart of a system, indicated generally at 100, for manufacturing a granule covered roofing shingle in accordance with this invention. In a first step 102 of the system 100, at least two sources of granules are established. The sources of granules may be geographically separated granule quarries, such as quarries in different geographic regions of the United States, or different geographic regions of the world. However, the sources of granules may be any other desired source of a suitable granule. Additionally, although the sources of granules illustrated in FIG. 2 are shown as being geographically separated granule quarries (labeled Quarry 1 and Quarry 2 in FIG. 2), the sources of granules may also be different portions of the same quarry, or any desired number of geographically separated quarries, or portions thereof. It will be understood however, that Quarry 1 and Quarry 2 can provide any desired number of granules from any desired number of quarries, such as one granule or more than two granules, and more than two quarries. In the embodiment illustrated in FIG. 2, Quarry 1 provides a first granule A₁ and a second granule B₁, and Quarry 2 provides a first granule A₂ and a second granule B₂, wherein the first granules A₁ and A₂ are of a first color, and the second granules B₁ and B₂ are of a second color.

Prime granules for use on shingles are typically made by quarrying rock, crushing and grading the rock to a particular particle size, and then coating the rock with a ceramic coating. It is the ceramic coating that can be colored to impart the desired color to the granules. For various reasons, granules of the same nominal color from different quarries are not always identical or interchangeable. For example, brown granules from two different quarries might not be the same shade when the granules are used to make shingles.

In a second step 104 of the system 100, a standardized process for manufacturing the granules A₁, B₁, A₂, and B₂ may be established to provide manufactured granules having a standardized appearance. The appearance of each of the granules A₁, B₁, A₂, and B₂ may be standardized so that the color of the first granule A₁ is substantially identical to the color of the first granule A₂, and the color of the second granule B₁ is substantially identical to the color of the second granule B₂, thereby defining manufactured granules A and B, respectively, as will be described in detail. It will be understood that the manufactured granules A and B each define a standardized granule color.

The standardized process for manufacturing granules, such as the granules A₁, A₂, B₁, and B₂, with a standardized appearance to define the respective manufactured granules A and B, each having a standardized granule color, can be accomplished by any desired method. For example, to ensure that the color of the first granule A₁ from Quarry 1 is substantially identical to the color of the first granule A₂ from Quarry 2, a color having a predetermined uniform color scale value, such as a predetermined L*a*b* color scale value (as defined using the CIELAB color space standard) can be selected. As used herein, when a color is expressed according to the CIELAB color space standard, L*=lightness, a*=the red/green value, and b*=the yellow/blue value.

A color measuring device, such as a colorimeter, can be used to sense the first granules A₁ and A₂ to ensure that they are substantially identical. As used herein, the color of the first granules A₁ and A₂ will be considered substantially identical if the total color difference ΔE between the first granules A₁ and A₂ is within the range of about +/−2.5 L*a*b* color units, wherein:

ΔE=[(ΔL²)+(Δa²)+Δb²)]^{1/2}.

In a particular embodiment, the ΔE between the colors of the first granules A₁ and A₂ is within the range of about +/−1.5 L*a*b* color units. In another embodiment, the ΔE between the colors of the first granules A₁ and A₂ is within the range of about +/−1.0 L*a*b* color unit.

Additionally, an observer test can be used to ensure that the color of a shingle having the first granule A₁ from Quarry 1 is substantially identical to the color of a shingle having the first granule A₂ from Quarry 2. In such an observer test, samples of shingles having the first granules A₁ and A₂ can be visually observed by an observer to ensure that the color of a shingle having the first granule A₁ from Quarry 1 is substantially identical to the color of a shingle having the first granule A₂ from Quarry 2.

The third step 106 of the system 100 may include manufacturing each of the manufactured granules A and B. As will be understood by a person skilled in the roofing shingle art, the manufactured granules A and B can be manufactured by applying a desired coating, such as a ceramic coating, to the granules A₁, B₁, A₂, and B₂ to thereby define the manufactured granules A and B having the standardized granule color according to the standardized process, as described herein above.

In a fourth step 108 of the system 100, the manufactured granules A and B from Quarry 1 and/or Quarry 2 may be transported to at least one shingle manufacturing facility or plant. As shown at 110 in FIG. 2, the manufactured granules A and B which originated at Quarry 1 and/or Quarry 2 can be transported to a first and/or a second shingle manufacturing plant (labeled Plant 1 and Plant 2, respectively, in FIG. 2). If desired, Plant 1 and Plant 2 can be located in different geographic regions of the United States, or different geographic regions of the world. As described herein above, the manufactured granules A are substantially identical in color and therefore can be used interchangeably at any desired shingle manufacturing plant, such as Plant 1 and/or Plant 2. Likewise, the manufactured granules B are substantially identical in color and therefore can be used interchangeably at any desired shingle manufacturing plant, such as Plant 1 and/or Plant 2. It will be understood that the manufactured granules A and B can be transported to any desired number of shingle manufacturing plants, such as one plant or more than two plants.

In a fifth step 110 of the system 100, a granule covered roofing shingle is manufactured using the manufactured granules A and B. The manufactured granules A and B can be used to form any desired number of color blends of granules. As described herein above, a granule covered roofing shingle S₁ produced at Plant 1 may include any combination of manufactured granules A and/or B from any of Quarry 1 and/or Quarry 2. Likewise, a granule covered roofing shingle S₂ produced at Plant 2 may include any combination of manufactured granules A and/or B from any of Quarry 1 and/or Quarry 2. Additionally, a shingle S₁ produced at Plant 1 and a shingle S₂ produced at Plant 2 may include any quantity and/or combination of the manufactured granules A and/or B from any of Quarry 1 and/or Quarry 2 within any color blend of granules. It will therefore be understood that the granules A₁ and A₂ can be used interchangeably. Likewise, the granules B₁ and B₂ can be used interchangeably.

The use of the manufactured granules A and/or B ensures that a color of a color blend of granules created with the manufactured granules A and/or B at Plant 1 can be substantially identical to a color of a color blend of granules created with the manufactured granules A and/or B at Plant 2. The ability to ensure such substantially identical color blends of granules at a plurality of shingle manufacturing plants further provides that a color of the granule covered roofing shingle S₁ produced at Plant 1 can be produced to be substantially identical to a color of the granule covered roofing shingle S₂ produced at Plant 2.

A color measuring device, such as a colorimeter, can be used to sense the shingles S₁ and S₂ to ensure that they are substantially identical. As used herein, the color of the shingles S₁ and S₂ will be considered substantially identical if the total color difference ΔE between the shingles S₁ and S₂ is within the range of about +/−2.8 L*a*b* color units. In a particular embodiment, the ΔE between the colors of the shingles S₁ and S₂ is within the range of about +/−2.0 L*a*b* color units. In another embodiment, the ΔE between the colors of the shingles S₁ and S₂ is within the range of about +/−1.3 L*a*b* color units.

Additionally, an observer test can be used to ensure that the color of the granule covered roofing shingle S₁ produced at Plant 1 is substantially identical to the color of the granule covered roofing shingle S₂ produced at Plant 2. In such an observer test, samples of the shingles S₁ and S₂ can be visually observed by an observer to ensure that the color of the shingle S₁ produced at Plant 1 is substantially identical to the color of the granule covered roofing shingle S₂ produced at Plant 2.

In a sixth step 112 of the system 100, the granule covered roofing shingles S₁ and S₂ are provided to a customer, such as a contractor or a homeowner, for use on a building roof. Because the color of the granule covered roofing shingles S₁ and S₂ is substantially identical, the shingles S₁ and S₂ from any of the shingle manufacturing plants, Plant 1 and/or Plant 2, can be combined or used interchangeably on a roof in an esthetically pleasing manner such that an observer will perceive the color of the shingles S₁ and S₂ as being substantially identical.

Advantageously, any of the shingles S₁ and/or S₂ may include granules from quarries in different geographic regions of the United States or the world. If the standardized process for manufacturing granules is followed, the manufactured granules, such as the manufactured granule A, will be substantially identical in color and therefore can be used interchangeably at any desired shingle manufacturing plant, regardless of the geographic origin of the granules. Further, if the standardized process for manufacturing granules is followed, the shingles S₁ and/or S₂ may be produced at a plurality of geographically separated manufacturing plants. Accordingly, the shingles S₁ and S₂ can have a color that does not vary, regardless of where the granules A and/or B originated. Additionally, because shingles S₁ and/or S₂ have a substantially identical color, the shingles S₁ and/or S₂ may be used interchangeably at any desired geographic location in the nation. Such shingles S₁ and S₂, may therefore be considered as having a national shingle color interchangeably usable at any geographic location.

Referring now to FIG. 3, there is illustrated a flow chart of a second embodiment of a system, indicated generally at 200, for manufacturing a granule covered roofing shingle in accordance with this invention. In a first step 202 of the system 200, at least two sources of granules are established. The sources of granules may be geographically separated granule quarries, such as quarries in different geographic regions of the United States, or different geographic regions of the world. However, the sources of granules may be any other desired source of a suitable granule. Additionally, although the sources of granules illustrated in FIG. 3 are shown as being geographically separated granule quarries (labeled Quarry 1 and Quarry 2 in FIG. 3), the sources of granules may also be different portions of the same quarry, or any desired number of geographically separated quarries, or portions thereof. It will be understood however, that Quarry 1 and Quarry 2 can provide any desired number of granules from any desired number of quarries, such as one granule or more than two granules, and more than two quarries. In the embodiment illustrated in FIG. 3, Quarry 1 provides a first granule A₁ and a second granule B₁, and Quarry 2 provides a first granule A₂ and a second granule B₂, wherein the first granules A₁ and A₂ are of a first color, and the second granules B₁ and B₂ are of a second color.

In a second step 204 of the system 200, the granules A₁, B₁, A₂, and B, from Quarry 1 and Quarry 2, respectively, may be transported to at least one shingle manufacturing facility or plant. As shown at 206 in FIG. 3, the granules A₁ and B₁, which originated at Quarry 1 can be transported to a first and/or a second shingle manufacturing plant (labeled Plant 1 and Plant 2, respectively, in FIG. 3). Likewise, the granules A₂ and B₂, which originated at Quarry 2 can be transported to a first and/or a second shingle manufacturing plant. If desired, Plant 1 and Plant 2 can be located in different geographic regions of the United States, or different geographic regions of the world. It will be understood that the granules A₁, B₁, A₂, and B₂ can be transported to any desired number of shingle manufacturing plants, such as one plant or more than two plants.

In a third step 208 of the system 200, the granules A₁ and B₁ may be combined at Plant 1 to form a first color blend. A granule covered roofing shingle S_{1A} is then manufactured using the first color blend. The granules A₂ and B₂ may also be combined at Plant 1 to form the first color blend and, subsequently, a granule covered roofing shingle S_{1B}. The granule covered roofing shingle S_{1A} produced at Plant 1 and having the first color blend formed from the granules A₁ and B₁ may therefore be substantially identical in color and appearance to the granule covered roofing shingle S_{1B} produced at Plant 1 and having the first color blend formed from the granules A₂ and B₂. Accordingly, the shingles S_{1A} and S_{1B} can be used interchangeably on a roof, as shown at 210 of the system 200.

Likewise, the granules A₂ and B₂ may be combined at Plant 2 to form a second color blend, as shown at 209 in FIG. 3. A granule covered roofing shingle S_{2A} is then manufactured using the second color blend. The granules A₁ and B₁ may also be combined at Plant 2 to form the second color blend and, subsequently, a granule covered roofing shingle S_{2B}. The granule covered roofing shingle S_{2B} produced at Plant 2 and having the second color blend formed from the granules A₁ and B₁ may therefore be substantially identical in color and appearance to the granule covered roofing shingle S_{2A} produced at Plant 2 and having the second color blend formed from the granules A₂ and B₂. Accordingly, the shingles S_{2A} and S_{2B} can be used interchangeably on a roof, as shown at 210 of the system 200.

It will be understood that the first color blend (A₁ and B₁) of the shingle S_{1A} may include any combination of additional granules so as to ensure that the shingle S_{1A} is substantially identical in color and appearance to the shingle S_{1B}. The first color blend (A₂ and B₂) of the shingle S_{1B} may also include any combination of additional granules so as to ensure that the shingle S_{1B} is substantially identical in color and appearance to the shingle S_{1A}.

Likewise, the second color blend (A₂ and B₂) of the shingle S_{2A} may include any combination of additional granules so as to ensure that the shingle S_{2A} is substantially identical in color and appearance to the shingle S_{2B}. The second color blend (A₁ and B₁) of the shingle S_{2B} may also include any combination of additional granules so as to ensure that the shingle S_{2B} is substantially identical in color and appearance to the shingle S_{2A}.

The ability to ensure such substantially identical color blends of granules at a manufacturing plant, regardless of the source of the component granules, provides significant flexibility for the manufacturing plant.

A color measuring device, such as a colorimeter, or an observer test, as described herein above, can be used to ensure that shingles, such as the shingles S_{1A} and S_{1B}, from a single manufacturing plant, such as Plant 1, are substantially identical to one another. For example, the color of the first color blend (A₁ and B₁) of the shingle S_{1A} and the color of the first color blend (A₂ and B₂) of the shingle S_{1B} will be considered substantially identical if the total color difference ΔE, as defined above, between the shingle S_{1A} and the shingle S_{1B} is within the range of about +/−2.8 L*a*b* color units.

In a particular embodiment, the ΔE between the colors of the shingle S_{1A} and the shingle S_{1B} is within the range of about +/−2.0 L*a*b* color units. In another embodiment, the ΔE between the colors of the shingle S_{1A} and the shingle S_{1B} is within the range of about +/−1.3 L*a*b* color unit.

While the embodiments discussed above have focused on manufacturing a granule covered roofing shingle with granules having a standardized appearance, it should be appreciated that in other embodiments the manufacture of a national shingle is a function of both the appearance of the shingle and the performance characteristics of the shingle. The term “national shingle”, as used herein, is defined to mean a shingle that has the same standardized appearance, has standardized performance characteristics and can be manufactured in more than one manufacturing facility. Accordingly, national shingles, manufactured in different manufacturing facilities, can be mixed on the same roof and provide a standardized appearance and a standardized performance.

As discussed above, the appearance of the national shingle is affected by the appearance of the standardized granules. In addition, the appearance of the national shingle can be affected by other variables in the manufacturing process. For example, the appearance of the national shingle can be affected by the non-limiting examples of manufacturing variables such as shingle blend formulation, blend drop dimension, blend drop shape, blend drop intensity, and blend patterns. Each of these manufacturing variables will be discussed in more detail below.

As discussed above, in order to provide a shingle having a color pattern of pleasing appearance, the colored portion of the shingles may be provided with areas of different colors. Usually the shingles have a background color and a series of granule deposits of different colors or different shades of the background color. The patterns of blend drops, formed by the combinations of the background color and the granule deposits of different colors, forms the shingle blend formulation. The shingle blend formation can have desired features, such as for example muted shades or striking color shades, enhanced dimensionality, shadow line color and blend drop intensity. In manufacturing a national shingle, the blend drop formulation is standardized from one manufacturing facility to another manufacturing facility.

One non-limiting example of a blend drop formulation is illustrated below in Table 1 for a national shingle manufacturing process with a continuous sheet moving at a speed of about 450 feet/minute (137 meters/minute).

TABLE 1
BLEND DROP FORMATION

| Blend | | Shingle | Blend Drop | |
|---|---|---|---|---|
| Drop | Granule | Location | Intensity | Percentage |
| Number | Number | Number | (tons/hour) | of Granules |
| 1 | 1 | 1 | 6.65 | 13% |
| | 2 | 2 | 3.65 | 7% |
| | 3 | 1 | 6.65 | 13% |
| | 4 | 3 | 34.61 | 67% |
| 2 | 4 | 4 | 10.68 | 23% |
| | 5 | 5 | 40.31 | 77% |
| 3 | 1 | 6 | 5.41 | 10% |
| | 2 | 7 | 3.05 | 5% |
| | 3 | 8 | 15.08 | 35% |
| | 4 | 9 | 25.54 | 50% |
| 4 | 2 | 10 | 11.25 | 25% |
| | 3 | 11 | 4.66 | 8% |
| | 4 | 3 | 34.61 | 67% |
| Background | 1 | 12 | 3.97 | 7% |
| | 2 | 13 | 7.09 | 14% |
| | 3 | 13 | 7.09 | 14% |
| | 4 | 14 | 33.52 | 64% |
| Shadow Line | 2 | 6 | 5.40 | 10% |
| | 4 | 15 | 30.39 | 60% |
| | 5 | 16 | 13.09 | 30% |

As shown in Table 1, the blend drop formulation includes a quantity of four blend drops and a quantity of five different standardized granules. The background includes a quantity of three different standardized granules and the shadow line includes a quantity of two different standardized granules. It should be appreciated that other blend drop formulations can be used to achieve shingles having other desired appearances.

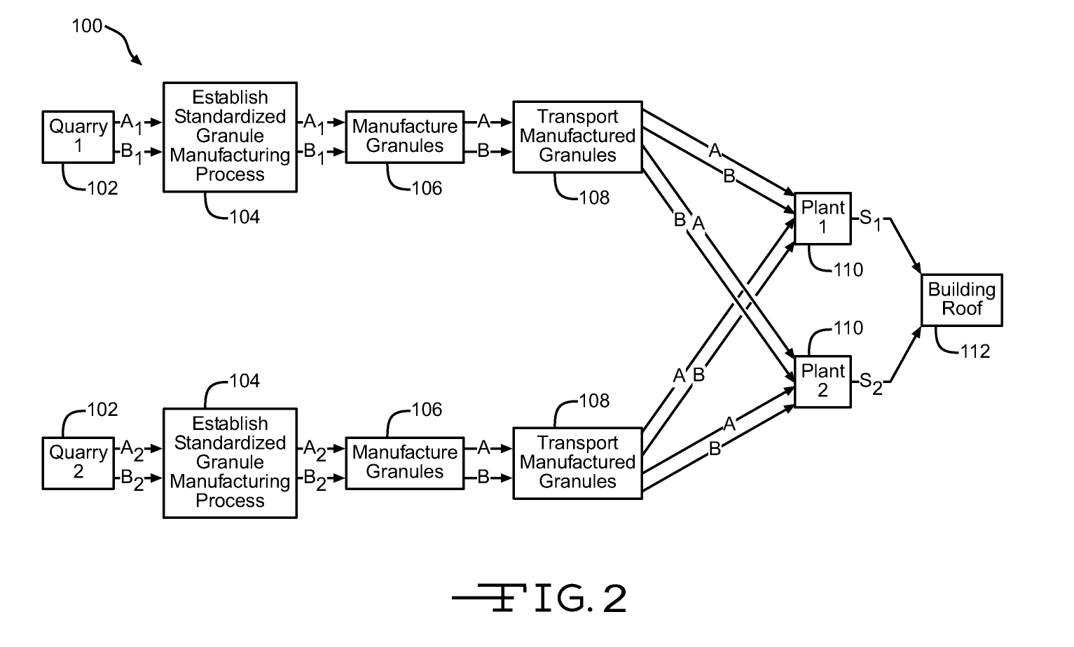

Referring now to FIG. 4, one embodiment of a national shingle is illustrated at 374. The national shingle 374 includes a blend drop 332. The blend drop 332 has a height dimension H and a length dimension L. In the illustrated embodiment, the height dimension H is in a range of from about 1.0 inches (2.54 cm) to about 6.0 inches (15.24 cm) and the length dimension L is in a range of from about 2.0 inches (5.08 cm) to about 20.0 inches (50.80 cm). Alternatively, the height dimension H can be less than about 1.0 inches (2.54 cm) or more than about 6.0 inches (15.24 cm) and the length dimension L can be less than about 2.0 inches (5.08 cm) or more than about 20.0 inches (50.80 cm). In manufacturing a national shingle, the height dimension H and the length dimension L of the blend drops are standardized from one manufacturing facility to another manufacturing facility.

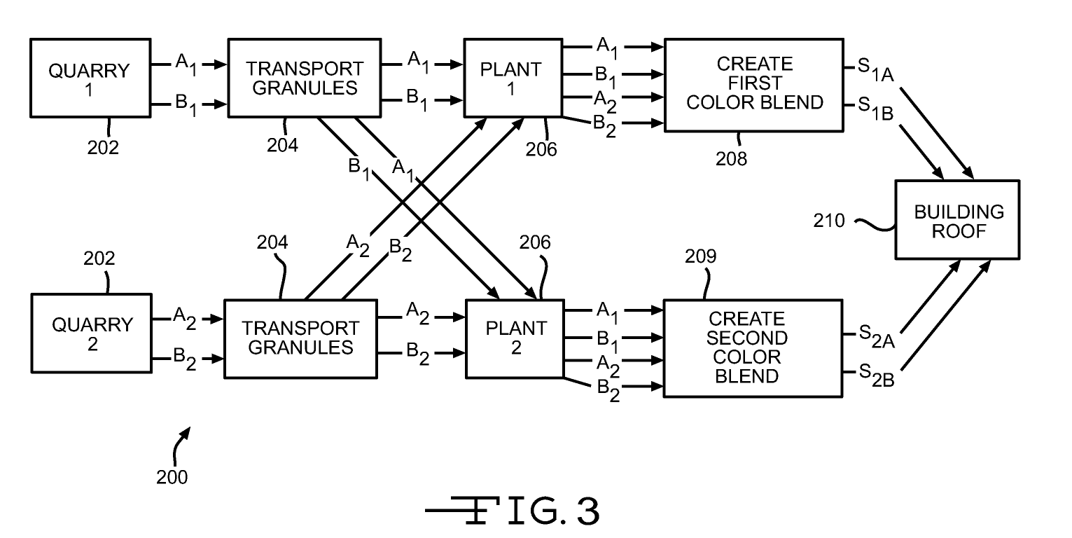

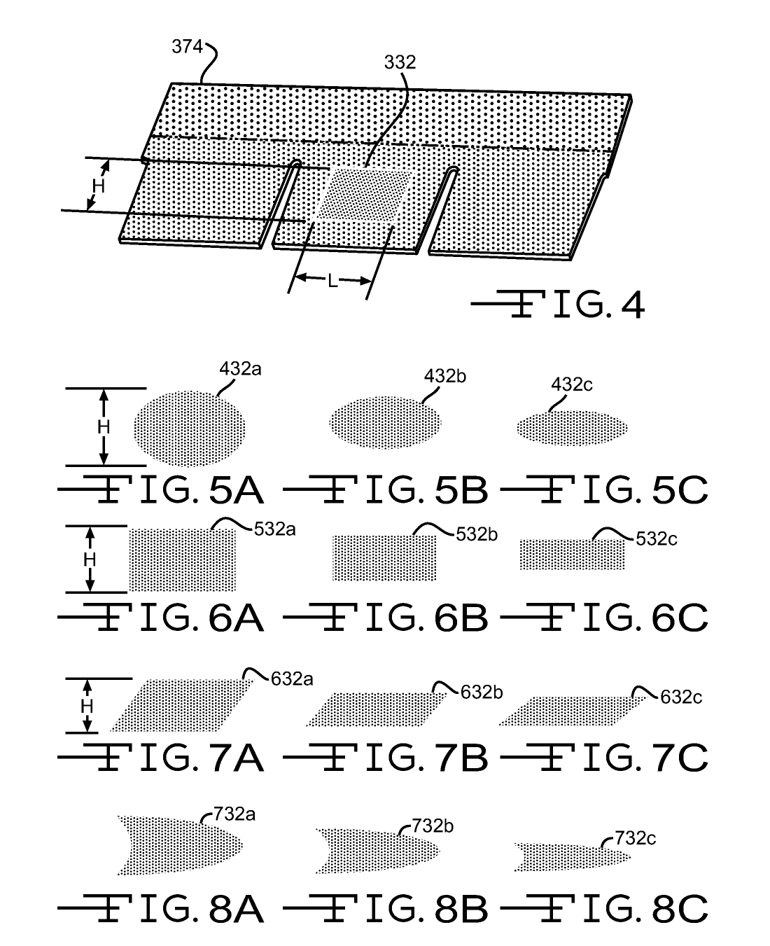

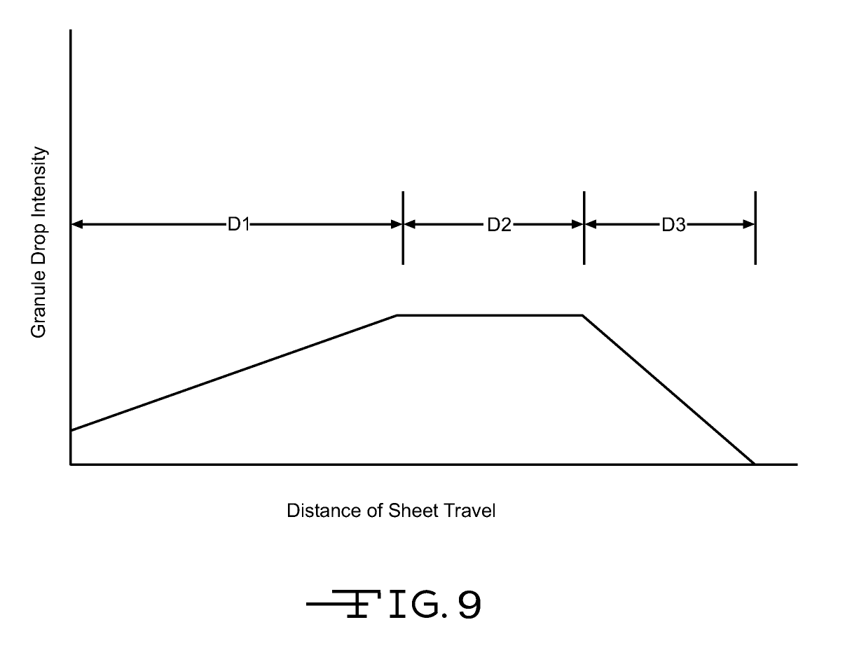

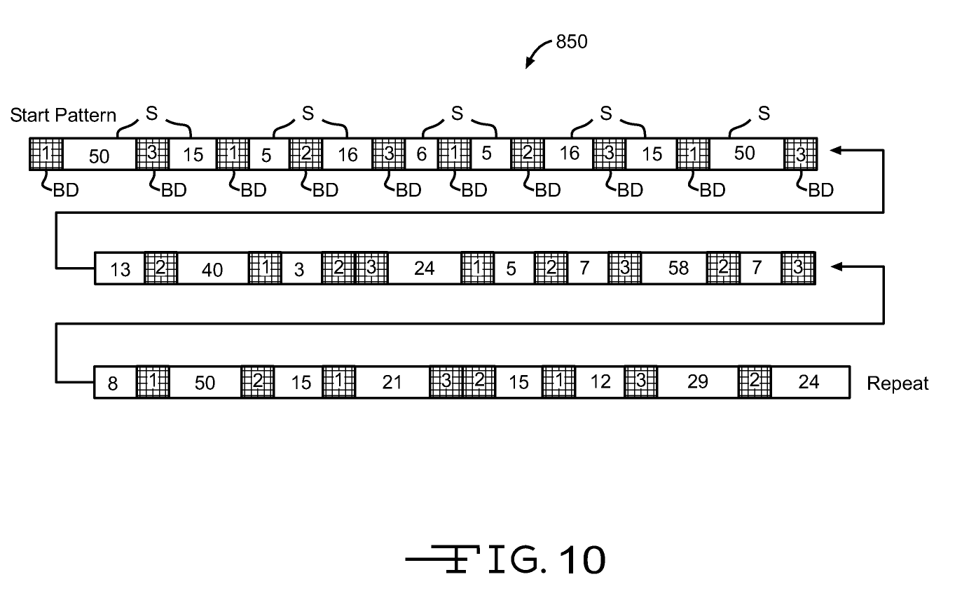

As discussed above, the appearance of the national shingle can be affected by the shape of the blend drop. Referring now to FIGS. 5a-5c, 6a-6c, 7a-7c and 8a-8c, various embodiments of the shape of a blend drop are illustrated. As shown in FIGS. 5a-5c, the blend drops 432a, 432b and 432c have a generally ovular shape with varying heights H. As shown in FIGS. 6a-6c, the blend drops 532a, 532b and 532c have a generally rectangular shape with varying heights H. As shown in FIGS. 7a-7c, the blend drops 632a, 632b and 632c have a generally parallelogrammatic shape with varying heights H. As shown in FIGS. 8a-8c, the blend drops 732a, 732b and 732c have a generally parabolic shape with varying heights H. In manufacturing a national shingle, the shape and corresponding height dimension of the blend drops are standardized from one manufacturing facility to another manufacturing facility.

As discussed above, the appearance of the national shingle can be affected by the intensity of the blend drop. The term “intensity”, as used herein, is defined to mean the quantity of granules deposited on the asphalt-coated sheet for a given time period as the asphalt-coated sheet moves through the shingle manufacturing process as described above and illustrated in FIG. 1. Referring now to FIG. 9, one embodiment of the intensity of a granule deposition is graphically illustrated. The graph of FIG. 9 includes three distances of sheet travel, D1, D2 and D3. The distance D1 represents the travel distance of the sheet in which the granules are initially deposited on the sheet by the granule dispensers (also known as the granule ramp). As shown in FIG. 9, during the distance D1 the intensity of the applied granules builds as the sheet travels downstream. The distance D2 represents the maximum, constant intensity of the granules applied to the sheet (also known as the granule body). The distance D3 represents the distance over which the granule dispensers are turned off, thereby resulting in an end to the application of the granules (also known as the tail). As shown in FIG. 9, during the distance D3 the intensity of the applied granules comes to an end. While the embodiment illustrated in FIG. 9 represents one embodiment of the intensity of the blend drop, it should be appreciated that the intensity of the blend drop and the associated distances D1, D2 and D3 can vary with other embodiments. In manufacturing a national shingle, the intensity of the blend drops is standardized from one manufacturing facility to another manufacturing facility.

As discussed above, the appearance of the national shingle can be affected by the patterns of the blend drops. The patterns result from the sequence of the different blend drops. For laminated shingles, the patterns can also be affected by the offset of various shingle layers. The sequence of the various blend drops are arranged such as to avoid clusters of light and dark blend drops. Referring now to FIG. 10, one embodiment of a pattern 850 of blend drops is illustrated. The various blend drops are shown generally in the shaded blocks labeled by the symbol BD. The numbers within the shaded blocks BD represent the number of the blend drop as discussed above. Each of the shaded blocks BD represents a nine inch blend drop. The blocks without the shading represent the spacing (in inches) between the blend drops and are labeled by the symbol S. In the embodiment illustrated in FIG. 10, the pattern 850 has a length 752.0 inches (1910.08 cm) and then repeats itself. It should be appreciated that the national shingle can have other patterns of different lengths. In manufacturing a national shingle, the pattern of the blend drops is standardized from one manufacturing facility to another manufacturing facility.

As discussed above, the manufacture of a national shingle can be a function of both the appearance of the shingle and the performance characteristics of the shingle. The performance characteristics of the national shingle can be affected by several variables in the manufacturing process. For example, the performance characteristics of the national shingle can be affected by the non-limiting examples of manufacturing variables such as the sealant performance, algicidal resistance, code compliance, fire resistance and storage characteristics.

Referring again to FIG. 1, in certain embodiments a sealant can be applied to one or more major surfaces of the granule-covered sheet 40. The sealant is configured to provide an adhesive seal for subsequent overlapping shingles or roofing materials when the shingles or roofing materials are installed on the roof. The performance of a sealant can vary depending on the environment parameters, the desired wind resistance requirements, the composition of the sealant and the thickness of the applied sealant. For example, a national shingle having a sealant that performs in the colder climate of the northern portions of the United States will also need a sealant that performs in the hotter southern portions of the United States.

One non-limiting example of an engineering specification for the desired wind resistance of the sealant of a national shingle is illustrated below in Table 2.

TABLE 2
WIND RESISTANCE SPECIFICATION

| | 3-Tab | 3-Tab | Laminate | Laminate |
|---|---|---|---|---|
| Wind | Shingle | Shingle | Shingle | Shingle |
| Speed | Min. Bond | Target Bond | Min. Bond | Target Bond |
| (Miles/hr) | (Lbs/3.75″) | (Lbs/3.75″) | (Lbs/3.75″) | (Lbs/3.75″) |
| 60 | 3.1 | 4.6 | 2.6 | 3.8 |
| 70 | 3.4 | 5.1 | 3.2 | 4.9 |
| 80 | 4.3 | 6.4 | 4.2 | 7.5 |
| 90 | 6 | 9.0 | 5.0 | 8.0 |
| 110 | 11 | 17.0 | 8.0 | 12.0 |
| 130 | n/a | n/a | 12.0 | 18.0 |

As shown in Table 2, both the minimum bond strength and the target bond strength at various wind speeds is specified for both 3-tab shingles and laminate shingles. It should be appreciated that the national shingle can have other desired bond strengths. It can be seen that it would be advantageous to fulfill the desire to mix shingles from different manufacturing plants if the shingles from the different manufacturing plants all meet the wind resistance specification of all of the areas serviced by all of the manufacturing plants.

As discussed above, the performance of the sealant can be affected by the composition of the sealant. Sealants can vary in composition from oxidized asphalts to polymer modified asphalts. The varying composition of the sealants can vary the performance of the sealant. One example of varying the composition of the sealant is to vary the polymer content of polymer modified asphalt. In certain embodiments, the polymer content of the sealant can be in a range of from about 0.0% of the total sealant weight to about 20.0% of the total sealant weight. In other embodiments, the polymer content of the sealant can be in a range of from about 3.0% of the total sealant weight to about 15.0% of the total sealant weight. Another example of varying the composition of the sealant is to vary the filler loading. In certain embodiments, the filler loading of the sealant can be in a range of from about 0.0% of the total sealant weight to about 50.0% of the total sealant weight. In other embodiments, the filler loading can be in a range of from about 20.0% of the total sealant weight to about 40.0% of the total sealant weight. Therefore, it can be seen that filler loading can be a performance parameter or performance characteristic that be can be standardized among multiple shingle plants in order to enable shingles from different plants to be mixed together on the same roof.

As discussed above, the performance of a sealant can vary depending on the thickness of the applied sealant. One non-limiting example of an engineering specification for the desired thickness of the sealant of a national shingle is illustrated below in Table 3 (for a specified wind speed range of 110 miles per hour to 130 miles per hour).

TABLE 3
SEALANT THICKNESS

| | 3-Tab | 3-Tab | Laminate | Laminate |
|---|---|---|---|---|
| Wind | Shingle | Shingle | Shingle | Shingle |
| Speed | Min. Thick. | Target Thick. | Min. Thick. | Target Thick. |
| (Miles/hr) | (Inches) | (Inches) | (Inches) | (Inches) |
| 60 | 0.010 | 0.015 | 0.009 | 0.014 |
| 70 | 0.011 | 0.017 | 0.010 | 0.016 |
| 80 | 0.013 | 0.020 | 0.012 | 0.018 |
| 90 | 0.015 | 0.022 | 0.014 | 0.021 |
| 110 | 0.020 | 0.300 | 0.017 | 0.025 |
| 130 | n/a | n/a | 0.023 | 0.035 |

As shown in Table 2, both the minimum thickness and the target thickness at various wind speeds is specified for both 3-tab shingles and laminate shingles. It should be appreciated that the sealant for the national shingle can have other desired thicknesses.

In manufacturing a national shingle, the environment parameters, the desired wind resistance requirements, the composition of the sealant and the thickness of the applied sealant can be standardized from one manufacturing facility to another manufacturing facility. This allows shingles from different plants to be mixed together on the same roof.

Referring again to FIG. 1, in certain embodiments an algicidal component can be added to the standardized granules. The algicidal component is configured to provide microbial growth resistance to the nationalized shingle. In some embodiments, the algicidal component can be a metallic substance, such as the non-limiting example of copper. Alternatively, the algicidal component can be other anti-microbial compounds or substances. In certain embodiments, the algicidal component in the form of granules is mixed with the nationalized granules in the form of granules. However, in other embodiments, the algicidal component can have other forms, such as for example, flakes. In still other embodiments, the algicidal component can be formed as a covering over the nationalized granules. Varying the form, substance and quantity of the algicidal component can vary the performance of the algicidal component. In one non-limiting example, the quantity of the algicidal component can be in a range of from about 0.0% of the total prime granule weight to about 15.0% of the total prime granule weight. In other embodiments, the algicidal component can be in a range of from about 0.0% of the total prime granule weight to about 10.0% of the total prime granule weight. In manufacturing a national shingle, the algicidal components are standardized from one manufacturing facility to another manufacturing facility.

As discussed above, the performance characteristics of the national shingle can be affected by code compliance requirements established by various governing bodies. The governing codes can be established by local, state or national authorities. As one example, a national shingle may be required to meet local codes in municipalities such as for example Miami, as well as meeting national Canadian requirements. According to the illustrated embodiment, the code compliance requirements are standardized from one manufacturing facility to another manufacturing facility.

While the embodiments illustrated in FIGS. 4-10 have described a “national shingle” as providing a standardized appearance and a standardized performance, it can be seen that manufacturing shingles having a standardized appearance allows mixing of shingles manufactured at different manufacturing facilities; likewise, manufacturing shingles having a standardized performance allows mixing of shingles manufactured at different manufacturing facilities. Accordingly, a national shingle may not have both a standardized appearance and a standardized performance, however, a national shingle can advantageously have both a standardized appearance and a standardized performance.

While the embodiments illustrated in FIGS. 4-10 have described as providing a standardized appearance and a standardized performance, it should be appreciated that a national shingle may have other characteristics, manufacturing parameters or performance criteria other than what has been discussed above. Non-limiting examples of other characteristics include puncture resistance, pallet design and wrapper thickness.

The principle and mode of operation of this invention have been described in its various embodiments. However, it should be noted that this invention may be practiced otherwise than as specifically illustrated and described without departing from its scope.

What is claimed is:

1. A system for manufacturing national shingles comprising the step of:
establishing a standardized process for manufacturing shingles having standardized performance characteristics;
wherein the national shingles can be manufactured in more than one manufacturing facility, and further wherein the national shingles can be mixed on a common roof and provide a standardized performance.

2. The system of claim 1, including the step of establishing a standardized process for manufacturing shingles having a standardized appearance.

3. The system of claim 1, wherein the step of establishing a standardized process for manufacturing national shingles having a standardized appearance includes standardizing a blend drop formulation.

4. The system of claim 3, wherein the step of establishing a standardized blend drop formulation includes standardizing blend drop features including color shades and shadow line color.

5. The system of claim 1, wherein the step of establishing a standardized process for manufacturing national shingles having a standardized appearance includes standardizing blend drop dimensions.

6. The system of claim 5, wherein the step of establishing standardized blend drop dimensions includes standardizing a blend drop height dimension and a blend drop length dimension.

7. The system of claim 1, wherein the step of establishing a standardized process for manufacturing national shingles having a standardized appearance includes standardizing a blend drop shape.

8. The system of claim 1, wherein the step of establishing a standardized process for manufacturing national shingles having a standardized appearance includes standardizing a blend drop intensity.

9. The system of claim 1, wherein the step of establishing a standardized process for manufacturing national shingles having a standardized appearance includes standardizing a blend drop patterns.

10. The system of claim 9, wherein the step of establishing a standardized blend drop pattern includes standardizing the sequence of different blend drops.

11. The system of claim 9, wherein the step of establishing a standardized blend drop pattern includes standardizing the offset of various shingle layers.

12. The system of claim 1, wherein the step of establishing a standardized process for manufacturing national shingles having standardized performance characteristics includes standardizing a sealant.

13. The system of claim 12, wherein the step of establishing a standardized sealant includes standardizing the composition and thickness of the sealant.

14. The system of claim 1, wherein the step of establishing a standardized process for manufacturing national shingles having standardized performance characteristics includes standardizing algidical resistance of the national shingle.

15. The system of claim 14, wherein the step of establishing a standardized algicidal resistance includes standardizing the weight of the algicidal components.

16. The system of claim 1, wherein the step of establishing a standardized process for manufacturing national shingles having standardized performance characteristics includes standardizing code compliance requirements of the national shingle.

17. A system for manufacturing national shingles comprising the step of:
establishing a standardized process for manufacturing shingles having standardized performance characteristics, the standardized performance characteristics including a standardized sealant;
wherein the national shingles can be manufactured in more than one manufacturing facility, and further wherein the national shingles can be mixed on a common roof and provide a standardized performance.

18. The system of claim 17, wherein the step of establishing a standardized sealant includes standardizing a sealant wind resistance specficiation.
